(19) United States
(12) Patent Application Publication
(10) Pub. No.: US 2025/0046141 A1
(43) Pub. Date: Feb. 6, 2025

(54) METHODS AND APPARATUS FOR GREETING CARD KIOSK

(71) Applicant: Ink’d Greetings, Inc., Phoenix, AZ (US)

(72) Inventor: Andrew Ekmark, Phoenix, AZ (US)

(73) Assignee: Ink’d Greetings, Inc., Phoenix, AZ (US)

(21) Appl. No.: 18/916,071

(22) Filed: Oct. 15, 2024

Related U.S. Application Data
(63) Continuation-in-part of application No. 18/200,519, filed on May 22, 2023.
(60) Provisional application No. 63/640,388, filed on Apr. 30, 2024.
(60) Provisional application No. 63/590,859, filed on Oct. 17, 2023.
(60) Provisional application No. 63/322,483, filed on Mar. 22, 2022.

(51) Int. Cl. G07F 17/26; G07F 9/02; G07F 11/72

(52) U.S. Cl. CPC G07F 17/266; G07F 9/0235; G07F 11/72

(57) ABSTRACT

A greeting card kiosk system for a user to customize a greeting card with a gift card printed thereon. The greeting card kiosk may comprise a computing device, a display, a user interface and a printer. The display is located on the kiosk and may be coupled to the computing device. The user interface may be controlled by the computing device for display on the display, wherein the user interface includes a greeting card option associated with customizing the greeting card. The printer may be coupled to the computing device configured to print out the greeting card with the gift card located thereon based on a user selection associated with the greeting card option.

### CROSS-REFERENCE TO RELATED APPLICATIONS

This application claims the benefit of U.S. Provisional Application Ser. No. 63/590,859 filed Oct. 17, 2023, and U.S. Provisional Application Ser. No. 63/640,388 filed Apr. 30, 2024, which are herein incorporated by reference in their entirety, and is a continuation-in-part of U.S. patent application Ser. No. 18/200,519, filed May 22, 2023, which claims the benefit of U.S. Provisional Application Ser. No. 63/322,483 filed Mar. 22, 2022, which are all hereby incorporated by reference herein in their entirety.

### BACKGROUND OF THE TECHNOLOGY

Greeting cards may be currently purchased in a variety of ways, reflecting both traditional and modern shopping habits. Greeting cards may be purchased in-store in physical retailers such as brick and mortar stores like supermarkets, drugstores, dedicated card shops (like Hallmark®), bookstores, and gift shops. A greeting card purchaser typically browses for the cards on a shelf or in an aisle. The shelves typically contain numerous iterations of greeting cards relating to anniversaries, birthdays, holidays, and the like. The greeting cards are pre-printed and chosen by the purchaser from store shelving according to the type of event or date being celebrated. The greeting cards include pre-printed illustrations and text. Since the greeting cards are mass produced, greeting card designs may be limited, and typically offer limited personalization. Greeting cards may also be purchased online from e-commerce platforms like Amazon®, Etsy®, and specialized greeting card websites that allow customers to browse a wide variety of designs and themes. There are also print-on-demand greeting cards that allow users to create custom cards that can be printed and shipped. Many of these offer personalization features, such as adding photos, custom messages, or selecting specific themes. Greeting cards may also be designed and customized using mobile apps that allow users to create, personalize, and send physical or digital cards directly from their smartphones.

Gift cards may also be purchased in ways similar to those described above. Specifically, gift cards are available at a wide range of retail locations, including grocery stores, department stores, drugstores, and dedicated gift card stands. Those gift cards are typically purchased directly from the brands, often from end cap locations or adjacent to check out in the stores. The gift cards may be from various credit card companies (e.g., Visa® gift card), restaurants, online shopping (e.g., Amazon®), or other gift card sources. The gift cards typically look like standard credit or debit cards and contain a set dollar amount that is attributed to the card. The stalls, aisles, end caps, and shelves that hold the greeting cards and gift cards for purchase require a large footprint in a store's floorplan. Gift cards may also be purchased from retailer websites and e-commerce platforms. Some retailers also have mobile phone applications that allow users to purchase, store, and manage gift cards.

The greeting card and gift card areas in retail locations require a substantial amount of floor space that allow purchasers to view and locate a gift and/or greeting card that is suitable for their needs.

### SUMMARY OF THE TECHNOLOGY

In one aspect of the subject disclosure, a greeting card kiosk system is provided to create or customize a greeting card and a gift card combination. The system includes a computing device. A display is coupled to the computing device. A user interface is displayed on the display by the computing device. The user interface may be controlled by the computing device for display on the display. The user interface may include a greeting card option associated with customizing the greeting card and the gift card to create the greeting card gift card combination. The user interface allows the user to select various greeting card options. A printer is coupled to the computing device and configured to print out a greeting card based on user selections associated with greeting card options.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1 is a front view of a kiosk station for generating on-demand user designed greeting cards according to an embodiment of the subject technology;

FIG. 2 is a front perspective view of the kiosk station for generating on-demand user designed greeting cards according to an embodiment of the subject technology;

FIG. 3 is a side perspective view showing a printer output side of the kiosk station according to an embodiment of the subject technology;

FIG. 4 is a side view showing the printer output side of the kiosk station according to an embodiment of the subject technology;

FIG. 5 is a front view of the kiosk station with a service door in the open position according to an embodiment of the subject technology;

FIG. 6 is a top view of the kiosk station with the service door in the open position according to an embodiment of the subject technology;

FIG. 7 is a perspective view of a frame of the kiosk station with an outer panel removed according to an embodiment of the subject technology;

FIG. 8 is a block diagram of a greeting card kiosk system according to an embodiment of the subject technology;

FIG. 9 is a flowchart of a process for generating a user-designed greeting card on site of a kiosk station according to an embodiment of the subject technology;

FIG. 10 is a block diagram of a computing device;

FIG. 11 represents a user interface with selectable options for a type of greeting card according to an embodiment of the subject technology;

FIG. 12 represents a user interface with selectable options for a listing of available of greeting cards in accordance with the type of greeting card according to an embodiment of the subject technology;

FIG. 13 represents a selection confirmation user interface according to an embodiment of the subject technology;

FIG. 14 represents a user interface allowing a user to personalize a message on the greeting card according to an embodiment of the subject technology;

FIG. 15 represents a user interface allowing a user to select a gift card to be added to the greeting card according to an embodiment of the subject technology:

FIG. 16 represents a user interface allowing a user to select an amount of the gift card to be added to the greeting card according to an embodiment of the subject technology;

FIG. 17 represents a user interface allowing a user to preview the greeting card and gift card combination according to an embodiment of the subject technology;

FIG. 18 represents a purchase summary user interface according to an embodiment of the subject technology;

FIG. 19 represents a user interface allowing a user to select a delivery option for the greeting card and gift card combination according to an embodiment of the subject technology; and

FIG. 20 represents a user interface for a payment page according to an embodiment of the subject technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of computing devices, peripherals, and printing devices. In addition, the present technology may be practiced in conjunction with any number of devices or methods for generating personalized greeting cards from user selections, and the system described is merely one exemplary application for the technology. Methods and apparatus for a greeting card kiosk according to various aspects of the present technology may operate in conjunction with any suitable paper, printer, or other device for producing a greeting card on demand.

In general, embodiments of the subject disclosure provide a greeting card kiosk for generating personalized or customized greeting cards. In some embodiments the greeting card may be adapted to include a gift card. In some embodiments, the user may create the greeting card on site at the kiosk. In some embodiments, the user may create the greeting card off site via a user interface of a software application available through a phone or computer either online or with a mobile software application installed on a user's personal device. The greeting card designed from the remote computing device may be forwarded to a computing device resident in the kiosk and printed at the kiosk. In some embodiments, the user may receive a QR code when the greeting card has been designed that they can scan at the kiosk when printing the greeting card. In various embodiments, the kiosk provides a store front with a wide variety of greeting card options in a much more compact floor space. The customer may create greeting cards that appear clean (absent sloppy handwriting) and select greeting card designs that may be more compatible and personal to the recipient.

A traditional greeting card is typically a folded piece of cardstock or high-quality paper, usually featuring an attractive design or artwork. Traditional greeting cards are commonly used for various occasions, including holidays (Christmas, Valentine's Day), life milestones (weddings, anniversaries), and expressions of gratitude or sympathy. They serve as a thoughtful, tangible way to convey emotions, celebrate an event, or offer support to someone special.

The greeting card may comprise an outer cover, a back, and an inside section. The outer cover may include an illustration, photograph, or pattern related to the occasion, such as flowers, festive decorations, or abstract designs. Greeting cards typically come in standard sizes and are paired with an envelope.

The inside section of the greeting card may be divided into two sections. One side may contain a pre-printed message, expressing sentiments like “Happy Birthday,” “Congratulations,” “Get Well Soon,” or “Thinking of You.” The other side is often left blank, allowing space for a personal handwritten note.

A gift card may comprise a physical or digital gift card. A physical gift card is typically a small, wallet-sized card, usually made of plastic that acts as a prepaid, stored-value card for use at specific retailers or businesses. Physical gift cards typically feature the company or store's branding on the front, along with the card's value, which can be a fixed amount. The back of a physical gift card generally includes a magnetic strip or barcode for scanning during transactions, along with instructions on how to activate and use the card, terms and conditions, and sometimes a PIN for online purchases.

A digital gift card, also known as an e-gift card or electronic gift card, is a virtual version of a traditional gift card that is delivered and redeemed entirely online. Instead of being a physical card, it exists as a digital code or QR code sent to the recipient via email or text message or through a mobile app. A QR code for the digital card may also be printed on the greeting card to create a greeting card gift card combination.

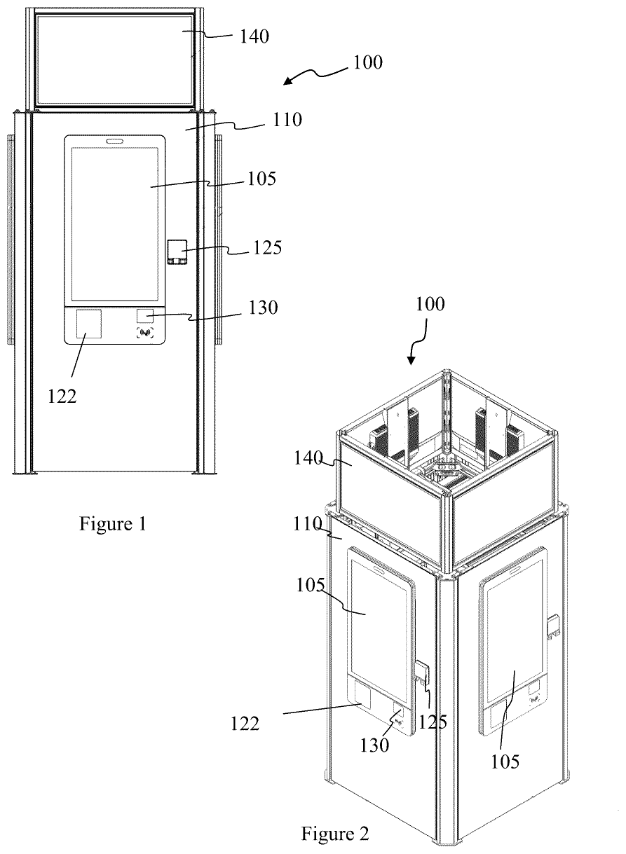

With reference to FIGS. 1-4, an example of a greeting card kiosk 100 according to one representative embodiment may comprise at least one electronic display 105 for displaying a user interface (UI) for customer users to engage with to order, design, and purchase customized greeting cards. The greeting cards may be customized by the user or may be selected by the user from the available greeting cards located in the kiosk 100. A second side of the kiosk 100 may include a second display 105 to allow multiple users to simultaneously create greeting cards. In some embodiments, the kiosk 100 may include a shell 110 that houses the display 105 and other elements that choose a greeting card or generate a customized greeting card.

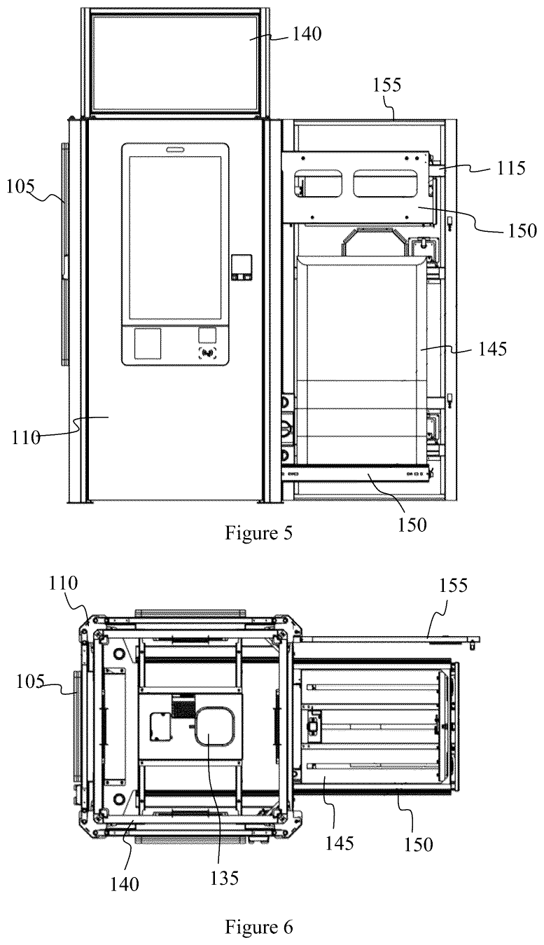

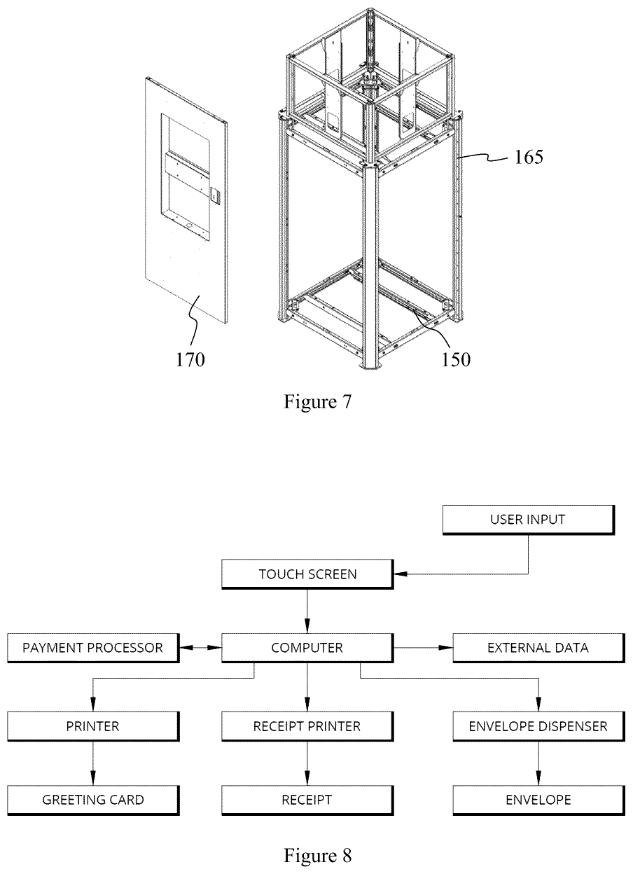

FIGS. 1-4 only show the external facing elements of the kiosk 100 and internal elements are generally hidden from view by the shell 110. Various internal elements are shown in FIGS. 5-8. In some embodiments, however, the shell 110 may include a window (not shown) that allows the user to watch as the greeting card is generated.

In one embodiment, the kiosk 100 comprises a computing device 115, shown in FIG. 5, installed within the shell 110 that coordinates the operation of multiple other elements in the kiosk 100. For example, the display 105 may comprise a touchscreen configured for tactile response to users' contact with different elements on the screen. The computing device 115 may include software to generate the UI that is shown on the display 105 and register user input selections for further processing actions that may include selecting various greeting card options, generating a ticket (concert, symphony, movie, sporting event, and the like), a coupon (store, prepaid), or generated AI content (poems, messages, photos) for printing on the greeting card, printing a greeting card, printing/loading/sending a gift card, processing payment, communicating with external parties through a network, and operating a dispenser 120 to dispense the greeting card and envelope.

The kiosk 100 may also comprise a scanner 122, such as for scanning a QR code received upon purchase of a greeting card gift card combination created by a user interface of a software application available through a phone or computer either online or with a mobile software application installed on a user's personal device. The greeting card gift card combination designed from the remote computing device may be forwarded to a computing device resident in the kiosk and printed at the kiosk. In some embodiments, the user may receive a QR code on their phone, tablet or other suitable device, once the greeting card gift card combination has been designed, that they can scan with scanner 122 at the kiosk 100 when printing the greeting card gift card combination.

Some embodiments may comprise a payment processing module 125 that may be separate from the display 105. The payment processing module 125 may be configured to receive cash, credit/debit card, or electronic payment, such as using near-field communication (NFC). For electronic payments, the payment processing module 125 may communicate through the computing device 115 with external entities to confirm the availability and transfer of funds for purchasing items through the kiosk 100. A separate printer 145 for purchase receipts may be connected to the computing device 115 and dispense receipts from a dedicated receipt slot 130. Alternatively, receipts may be dispensed from the same dispenser 120 as used for the greeting card.

The kiosk 100 may further comprise a camera (not shown) to allow the user to take a picture (e.g., selfie) and have it printed onto the greeting card selected during the design process. The computing device 115 may be configured to allow a user to upload an image that can be printed onto the greeting card. For example, the kiosk 100 may comprise a wireless internet router/antenna 135 (see FIG. 6) that allows the kiosk 100 to communicate over a wireless network such as Bluetooth, 3G, 4G, 5G, or a LAN.

Referring to FIG. 8, additional elements of the kiosk 100 according to some embodiments may reside completely within the shell 110 or be arranged along an exterior facing surface of the shell 110. For example, the block in FIG. 8 that is labeled “external data” may include additional communication devices such as fiber optic cables, an antenna, or internet router that are configured to communicate over one or more communications methods over a network with remote entities. In one embodiment, the computing device 115 may be able to access a remote storage system to access additional greeting card designs or to download updated designs based on an approaching holiday or event. As described above, the computing device 115 may also be able to receive an image from the user's device, such as phone, computer, tablet, and the like that can be printed on the selected greeting card.

Referring again to FIGS. 1-4, the kiosk 100 may further comprise one or more surfaces dedicated to providing advertising space or related signage. In one embodiment, the kiosk 100 may comprise one or more screens 140 that display advertising or other information. For example, the screens 140 may comprise a video display for advertising related to the retail location where the kiosk 100 is installed. Alternatively, the screens 140 may display videos directed towards attracting customers to use the kiosk 100. The computing device 115 may also be configured to work with or be integrated into a given retail establishment's customer loyalty program or discount coupon. In this way, a given kiosk 100 may be customized according to each installed location.

The kiosk 100 may further comprise a printer 145 installed within the shell 110 that receives greeting card formatted data from the computing device 115. The user selections are sent from the computing device 115 to the printer 145. The computing device 115 may select a card stock from a card stock repository that matches the user selection size. A picker or other card grabbing mechanism may pull the selected card stock to the printer 145. In some embodiments, the printer 145 may include a series of paper trays configured to hold a finite number of card stock sizes, or in some embodiments, a single uniform card stock size. The printer 145 may format the data to match the card stock or simply receive printing instructions from the computing device 115 and generate the greeting card based on the user selected input through the UI.

The card stock may include score lines so that the user can fold the printed cardstock into the proper format. The display 105 may also provide instructions to the user on how to properly fold the cardstock. In an alternative embodiment, the printer 145 may be configured to fold the printed cardstock prior to dispensing the generated greeting card. In yet another embodiment, the computing device 115, UI, and printer 145 may be configured to print additional items such as postcards, business cards, invitations, place cards, or other similar printed products.

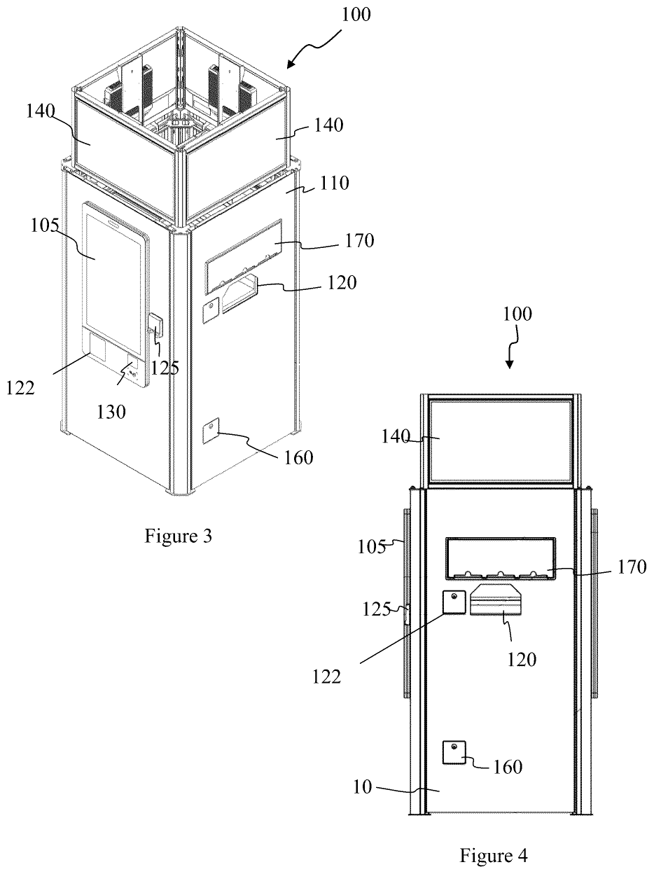

With reference now to FIGS. 5-7, the kiosk 100 may be configured to allow for ease of maintenance. In one embodiment, the shell 110 may include a service door 155 that may be used to access internal components such as the printer 145, the computing device 115, communication devices, and paper supplies. Internal components may be installed on one or more racks 150 configured to increase accessibility of the internal components for maintenance. For example, racks 150 may be configured to slide in and out of an internal volume of the shell 110 when a service door 155 is open. When closed, the service door 155 may be retained in a locked position by an externally accessible lock 160 (see FIGS. 3 and 4).

The computing device 115 may also be configured to monitor and report various states of the kiosk 100. For example, the computing device 115 may be able to report ink and paper levels associated with the printer 145. At predetermined levels, a signal may be generated or sent to a selected individual so that ink or paper may be replenished prior to running empty. The computing device 115 may also report kiosk 100 status reports such as power or wi-fi outages or other system malfunctions to a central server to facilitate maintenance.

The shell 110 may be formed of a frame 165 configured to provide an attachment point for the racks 150 and one or more external panels 170. The external panels 170 may be attached to the shell 110 by any suitable method and comprise one or more openings that correspond to individual components such as the display 105 or card dispenser 120. Then frame 165 may comprise any suitable material such as metal columns or L-brackets fixed together by mechanical fasteners or welded joints.

In an alternative embodiment, the kiosk 100 may be reduced in size to be more compact and take advantage of existing hardware at a given location. For example, the shell 110 may be reduced in size to eliminate the need for a dedicated printer 145. In this embodiment, the form factor may be reduced to the size of a tablet style computing device 115 with an online payment system. The designed greeting card may then be printed by an on-site printer 145 that is in communication with the kiosk 100.

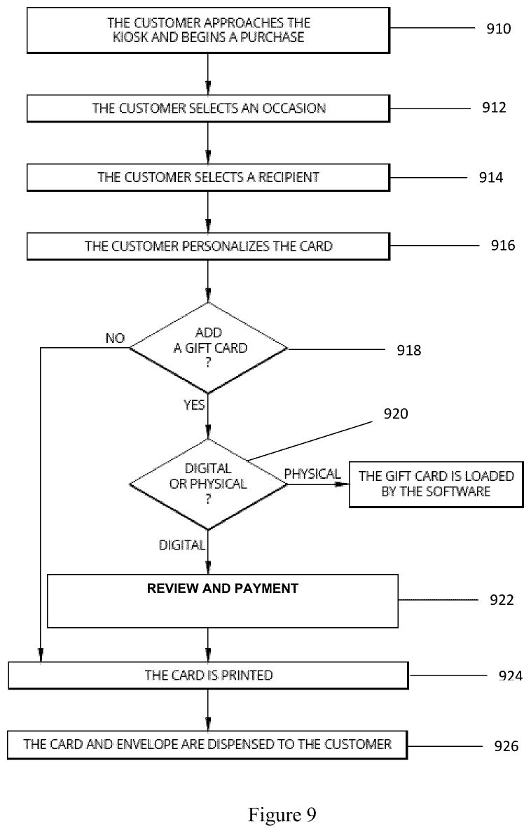

During operation, and referring now to FIG. 9, a user may approach a kiosk station, for example, a kiosk 100 as described above with respect to FIGS. 1-4 and commence designing a greeting card for purchase (910). Once the user selects to begin the card creation process, the UI may present on the electronic display 105 a series of selectable options for the occasion (912). The selectable options may comprise a catalog of greeting card themes, graphics for insertion on the cover of card stock, graphics for insertion on the interior of cardstock, pre-defined greeting messages, a recipient's name, an electronic keyboard for receipt of user authored messages, preselected card stock sizes, and envelope sizes and colors. The user may select an available greeting card or customize a greeting card. The user may then select an occasion. The occasion may comprise anniversaries, birthdays, congratulations, sympathy, thank you and the like. The user may then select a recipient (914). The user may then personalize the greeting card by adding a message and/or signature (916). The user may have the option of using modern or classic font or handwriting the message on the electronic display 105.

Once the user has personalized the greeting card, the UI may ask the user if they would like to add a gift card to the greeting card (918). A “gift card” as used herein refers to a card or token that can be exchanged for a specified cash value of goods or services from a particular business or third-party store/merchant, given as a gift. On a negative input, the customized greeting card is printed once the user has provided payment.

On an affirmative input and selection of the type of gift card (920), the UI may ask the user the amount of the gift card they would like to provide. Upon selection of the gift card amount, the UI then provides a preview of the greeting card combined with the gift card for the user to review. After review and payment (922), the gift card may be printed on the back of the greeting card at (924). If no gift card is added the card is printed at (924) after step (918). The gift card can be placed anywhere visible on the greeting card, include the front cover, the inside portion, or the back.

In some embodiments, the computing device 115 may automatically select an envelope to match the size and/or color scheme of the card. The user selections may be stored temporarily in computing memory until a user confirms the entirety of the selections.

Upon completion of the user selected portion of the greeting card creation process, the computing device 115 may cause the printer 145 to receive the appropriate card stock and begin the printing process. The final printed card may then be dispensed from the printer 145 out of the dispenser 120 for collection by the user. An envelope may be dispensed in tandem with the greeting card through the slot 16 or through a dedicated envelope dispenser 170. The greeting card may be moved from the printer 145 and tucked under the envelope flap so that both the greeting card and envelope are dispensed simultaneously at 926. In some embodiments, the greeting card and envelope are dispensed one after the other.

As discussed above, some embodiments may include the option to include a gift card with the greeting card. Various embodiments may generate physical or electronic gift cards. In some embodiments, the gift card may be a physical gift card or an electronic gift card. If a physical gift card is selected the physical gift card will be dispensed in tandem with the greeting card to create the greeting card gift card combination. If an electronic gift card is selected the electronic gift card will be included with the greeting card to create the greeting card gift card combination. In some embodiments, the gift card will be printed on the greeting card to create the greeting card gift card combination

For example, during the card creation process, the software providing the UI may generate an inquiry of whether the user wishes to purchase a gift card to accompany the greeting card. On an affirmative input by the user, the computing device 115 may ask whether the user wants a digital or physical gift card. For selections of a physical gift card, the computing device 115 may access merchant information to generate a valid gift card for a specific third-party merchant. The gift card may be selected from a collection of available gift cards stored within the shell 110 or the printer 145 may be instructed to print a physical gift card that includes the requisite information for confirming that the gift card is valid. A suitable envelope matched with the size of the gift card may be selected by the computing device 115 and dispensed to the user in tandem with the greeting card and gift card combination. The computing device 115 may also be configured to print the address and identification information of the user and recipient of the gift card on the envelope.

For a digital selection, the computing device 115 may interface with a gift card registry for a selected merchant and cooperate with the registry to generate digital information associated with the gift card. The digital gift card may be electronically sent to an account or email address or texted to a phone number designated by the user that will allow the recipient to access it at a later time.

The computing device 115 may be configured to provide instructions to the printer 145 that result in the digital gift card being printed directly onto the greeting card along with the other selected options to create the greeting card gift card combination. In this way, the digital gift card is integrated into or onto the greeting card itself. The digital gift card may be integrated into part of the design of the greeting card or may simply be printed onto any suitable page or surface of the greeting card. The digital gift card may exist as a digital code or QR code printed on any suitable page or surface of the greeting card to create the greeting card gift card combination.

Additionally, during the greeting card creation process, the software providing the UI may generate an inquiry of whether the user wishes to personalize the greeting card by adding other content to the greeting card. On an affirmative input by the user, the computing device 115 may ask the user whether the user would like to add or generate a ticket, coupon, pre-selected content, or AI-generated content to the digital card or be printed on the greeting card during design of the digital card and/or the greeting card. The ticket may comprise any type of ticket, including but not limited to a ticket to a movie, concert, symphony, sporting event, comedy club, or any other event that requires a ticket. The coupon may comprise a typical store or retail coupon, or a prepaid coupon, such as Groupon, and the like. The AI-generated content may comprise a poem, text, message, photo, or any other type of user content that is generated by any suitable AI platform/generator/engine.

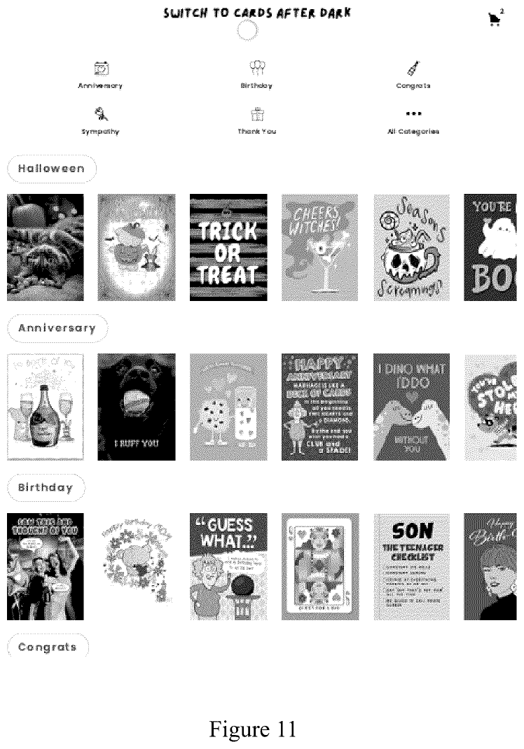

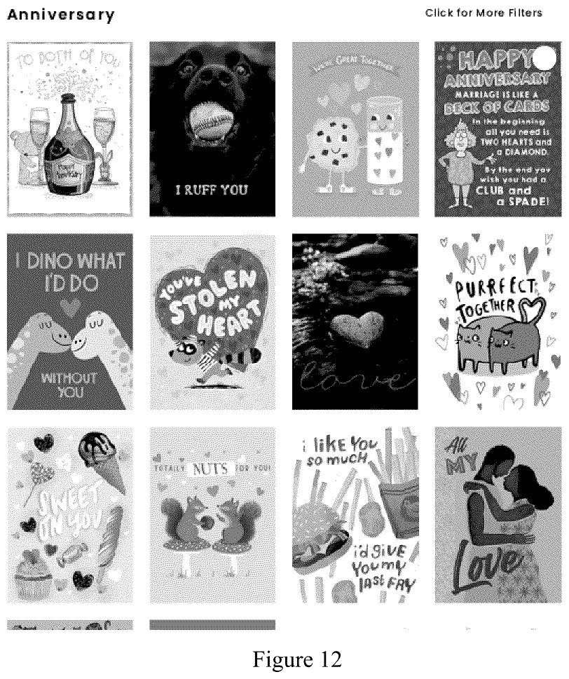

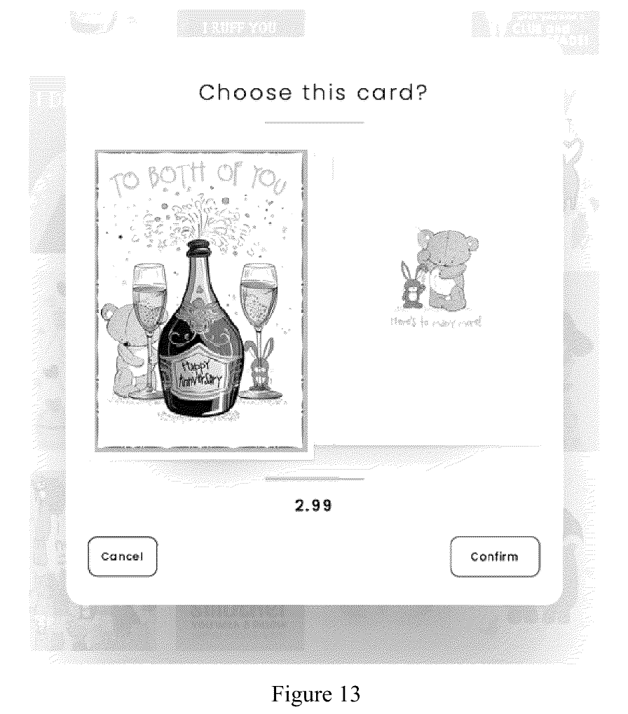

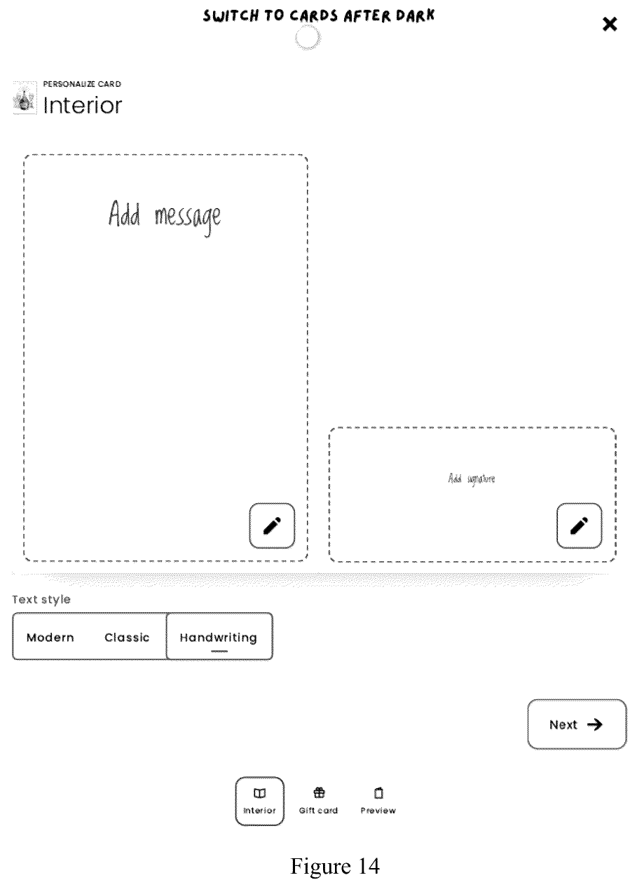

In some embodiments, referring now to FIGS. 11-20, a website and/or phone app greeting card gift card combination creation process may comprise printing the greeting card gift card combination at a kiosk 100, such as in accordance with the method described above. Alternatively, in some embodiments, the greeting card gift card combination may be mailed to the user or greeting card gift card combination recipient. For example, a user may access the UI via a website or a phone app and participate in a card selection process. The user may select the option to commence designing a greeting card for purchase. Once the user selects to begin the greeting card creation process, the UI via the website or app software may present a series of selectable options such as shown in FIG. 11. The options may include the categories of what type of greeting card will be designed. Some examples include anniversaries, birthdays, congratulations, sympathy, thank you and the like. For example, a user may select the broad category of anniversary. The UI may then provide a listing of available cards for the specific Anniversary category (FIG. 12). The UI may also include a toggle of “switch to cards after dark” which allows the user to select from more adult-related content. Once the user selects a card, the UI may ask the user to confirm the selection (FIG. 13). Once the user confirms the selection, the user may then add a message and signature (FIG. 14). At this step, the user may be offered options, such as modern font, classic font, or handwriting (if their computer/app has touch capabilities), for presenting the message.

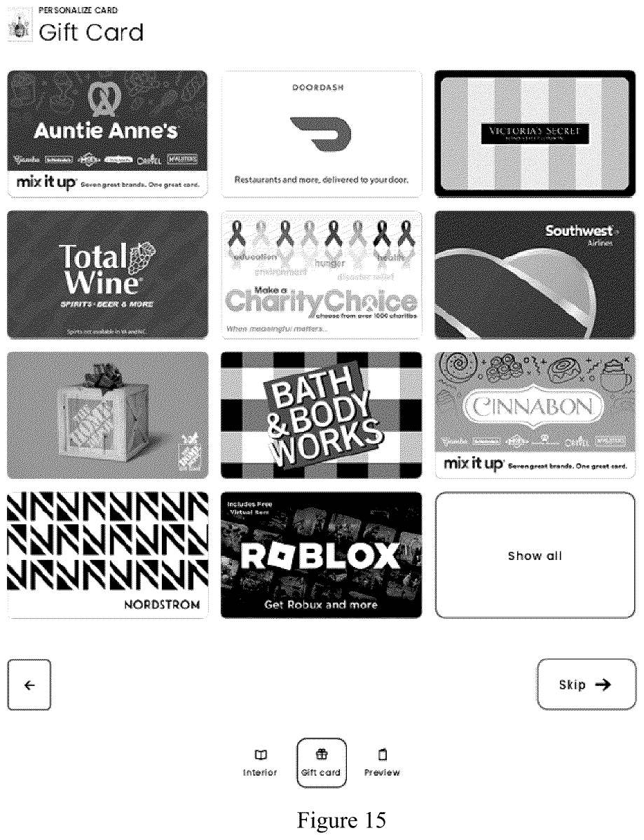

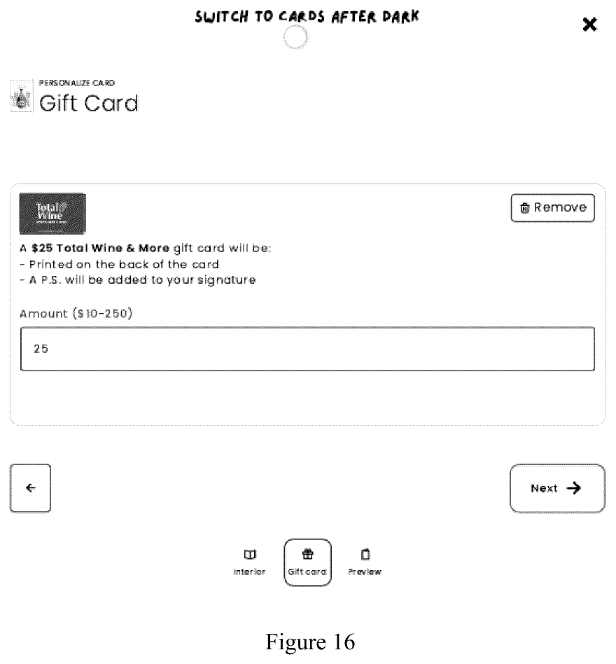

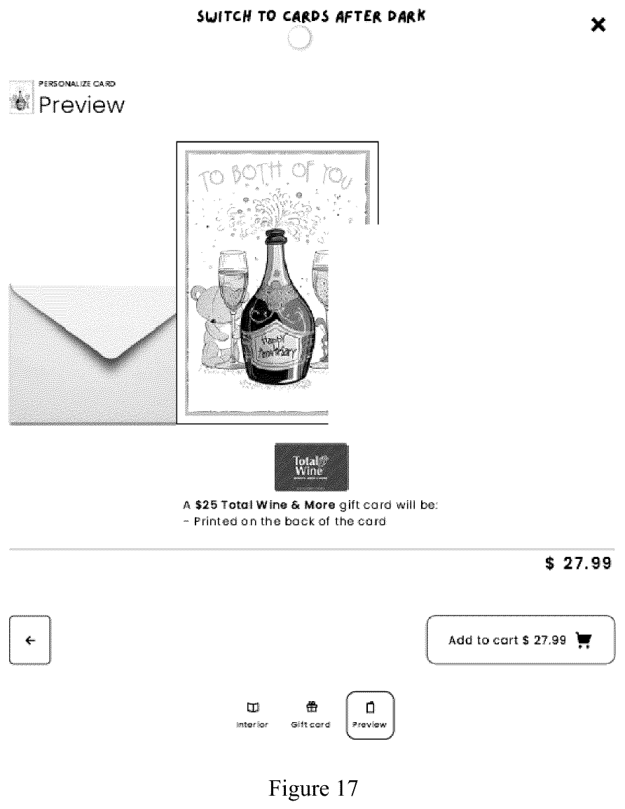

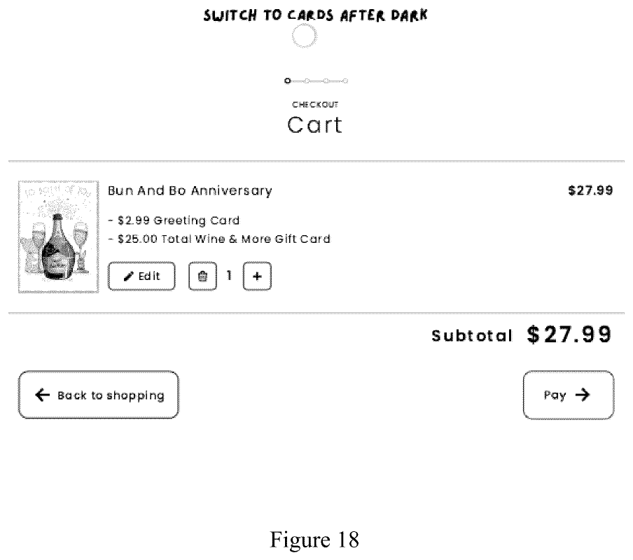

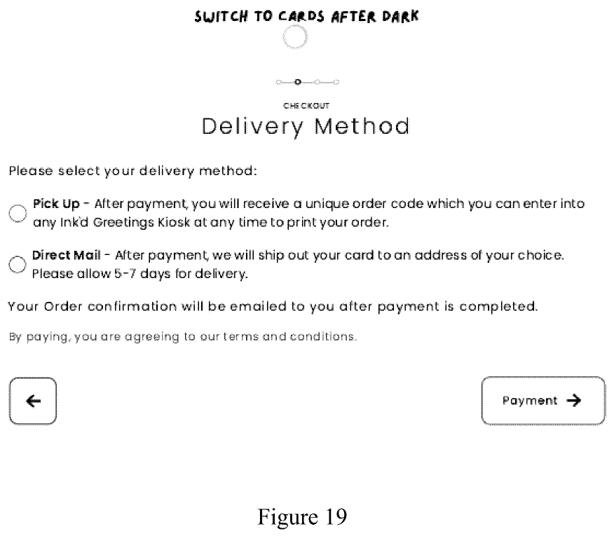

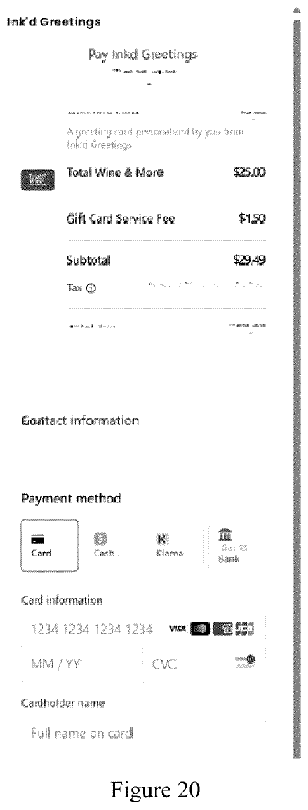

Once the user has added the message and signature, the UI may ask the user if they would like to add a gift card to the greeting card (FIG. 15). The gift card may be a physical gift card or a digital gift card. On an affirmative input and selection of the type of gift card, the UI may ask the user the amount of the gift card they would like to provide (FIG. 16). Upon selection of the gift card amount, the UI may provide a preview of the greeting card combined with the gift card for the user to review (FIG. 17). A physical gift card may be placed with the greeting card within the envelope when dispersed. The digital gift card may be printed on the back or any other suitable location on the greeting card. The digital gift card can be placed anywhere visible on the greeting card. Upon review, the UI directs the user to checkout and pay (FIG. 18). Upon checkout, the UI may ask the user to select the delivery method (FIG. 19). The user may then select the option to pick up the greeting card gift card combination at the kiosk or to have the greeting card gift card combination directly mailed to them or the chosen recipient. Once the delivery option has been selected, the user is directed to the payment screen (FIG. 20) to complete the purchase.

If the user selects the pick-up at kiosk 100 option, once the purchase is complete, the user will receive a digital receipt with the confirmation and order details. The user may also receive a QR code on their phone or tablet, which they could scan via scanner 122 at the kiosk 100. The user may then proceed to the kiosk 100 to retrieve their greeting card gift card combination, which would be dispensed by the kiosk 100.

Reference to a computer system or server may be described in the general context of computer system executable instructions, such as program modules, being executed by a computer system (described for example, below). In some embodiments, the computer system/server may be a cloud computing node connected to a cloud computing network (not shown). The computer system/server may be practiced in distributed cloud computing environments where tasks are performed by remote processing devices that are linked through a communications network. In a distributed cloud computing environment, program modules may be located in both local and remote computer system storage media including memory storage devices.

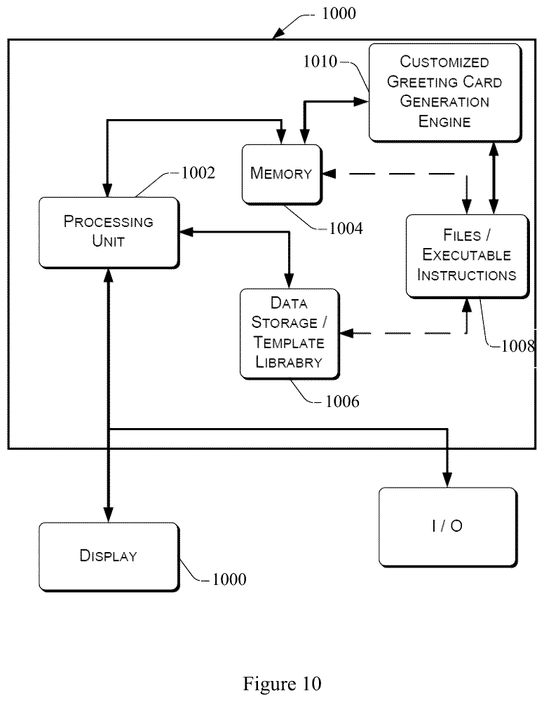

Referring now to FIG. 10, a general computing device 1000 is shown according to an exemplary embodiment. The components of the computing device 1000 may include one or more processors or processing units 1002, a system memory 1004, storage 1006, a computer program product 1008 having a set of program modules including files and executable instructions, a customized greeting card generation engine 1010 for generating user designed greeting cards, and a bus system that couples various system components including the system memory 1004 to the processor(s) 1020. The memory storage 1004 may store for example, user data, user selected/input greeting card data, card stock availability, and payment information. The storage 1006 may comprise a medium storing computer readable instructions, wherein the computer readable instructions cause the computing device to send a digital version of the gift card electronically to an electronic destination input by the user. The storage 1006 and template library may store files of pre-defined greeting cards, greeting card designs, and greeting card messages. The customized greeting card generation engine 1010 may include executable files that generate user customized graphics and text designs to be printed onto the card stock, which may be completely original or partially in supplement or instead of stored template elements.

The computing device 1000 may be described in the general context of computer system executable instructions, such as the program modules which represent a software embodiment of the system and processes described generally above with respect to FIG. 9. The program modules generally carry out the functions and/or methodologies of embodiments as described above including for example, designing customized or template-based greeting cards.

The technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples. Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. A greeting card kiosk system for a user to customize a greeting card with a gift card printed thereon, comprising:
a computing device;
a display responsive to the computing device;
a user interface controlled by the computing device and displayed on the display, wherein the user interface includes a greeting card option associated with customizing the greeting card; and
a printer responsive to the computing device, wherein the printer prints the greeting card with the gift card located thereon based on a user selection associated with the greeting card option.

2. The greeting card kiosk system of claim 1, further comprising a payment processor module responsive to the computing device, wherein the payment processor module processes an electronic payment from the user interacting with the user interface.

3. The greeting card kiosk system of claim 1, wherein the display processes tactile input from the user.

4. The greeting card kiosk system of claim 1, further comprising a shell internally housing the computing device, the printer, and an envelope dispenser, and wherein the display is positioned on a front side of the shell.

5. The greeting card kiosk system of claim 4, wherein the shell includes a slot positioned to dispense the greeting card and an envelope.

6. The greeting card kiosk system of claim 1, wherein the user interface includes an option for generating a digital gift card to dispense with the greeting card.

7. The greeting card kiosk system of claim 6, wherein the computing device includes a medium storing computer readable instructions, wherein the computer readable instructions cause the computing device to send a digital version of the gift card electronically to an electronic destination input by the user.

8. The greeting card kiosk system of claim 1, wherein the user interface includes an option for at least one of generating and loading a physical gift card to dispense with the greeting card.

9. The greeting card kiosk system of claim 8, wherein the computing device includes a medium storing computer readable instructions, wherein the computer readable instructions cause the computing device to dispense the physical gift card in tandem with the greeting card and the envelope.

10. The greeting card kiosk system of claim 1, wherein the printer comprises multiple paper trays adapted to dispense multiple types of card stock according to the user selected greeting card option.

11. A greeting card kiosk system for a user to create a greeting card and a gift card combination, comprising:
a computing device;
a display responsive to the computing device;
a user interface responsive to the computing device and displayed on the display, wherein the user interface includes a greeting card option associated with customizing the greeting card and the gift card to create the greeting card gift card combination; and
a printer responsive to the computing device, wherein the printer prints the greeting card gift card combination based on a user selection associated with the greeting card option.

12. The kiosk system of claim 11, further comprising a payment processor module responsive to the computing device, wherein the payment processor module processes an electronic payment from the user interacting with the user interface.

13. The kiosk system of claim 11, wherein the display processes tactile input from the user.

14. The kiosk system of claim 11, further comprising a shell internally housing the computing device, the printer, and an envelope dispenser, and wherein the display is positioned on a front side of the shell.

15. The kiosk system of claim 14, wherein the shell includes a slot positioned to dispense the greeting card gift card combination and an envelope.

16. The kiosk system of claim 11, wherein the user interface includes an option for generating a physical gift card to dispense with the greeting card gift card combination.

17. The kiosk system of claim 11, wherein the user interface includes an option for generating a digital gift card to dispense with the greeting card gift card combination.

18. The kiosk system of claim 17, wherein the computing device includes a medium storing computer readable instructions, wherein the computer readable instructions instruct the computing device to send a digital version of the greeting card gift card combination electronically to an electronic destination input by the user.

19. The kiosk system of claim 11, wherein the user interface includes an option for at least one of generating and loading a physical gift card, wherein the physical gift card is dispensed with the greeting card gift card combination.

20. The kiosk system of claim 19, wherein the computing device includes a medium storing computer readable instructions, wherein the computer readable instructions instruct the computing device to dispense the physical gift card in tandem with the greeting card gift card combination and an envelope.

21. A method for creating a greeting card gift card combination using the greeting card kiosk system of claim 11, comprising:
selecting an option for a greeting card; wherein the option may comprise an occasion;
selecting a recipient for the greeting card;
personalizing the greeting card; and
selecting a gift card to accompany the greeting card, wherein the gift card is printed on the greeting card to create the greeting card gift card combination.
